(19) United States
(12) Patent Application Publication
(10) Pub. No.: US 2007/0083688 A1
(43) Pub. Date: Apr. 12, 2007

(54) Common memory transfer control circuit and common memory transfer control system

(75) Inventor: Shinichi Abe, Kawagoe-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/244,286

(22) Filed: Oct. 6, 2005

(51) Int. Cl. G06F 13/00; G06F 13/14

(52) U.S. Cl. 710/240; 710/110

(57) ABSTRACT

A common memory transfer control circuit 2 is equipped with a transfer request congestion number detecting circuit 6 for detecting a transfer request congestion number RML indicating the multiplicity of transfer requests from transfer request signals REQ1 to REQn, a transfer request level signal maximum value detecting circuit 7 for detecting a transfer request signals maximum value LVMAX corresponding to the maximum value from transfer request level signals LV1 to LVn, a transfer clock controller 8 for controlling the frequency of a transfer clock TCLK on the basis of the transfer request congestion number RML and the transfer request level signal maximum value LVVMAX, and an access right arbitrating circuit 5 for arbitrating an access right of plural master devices 31, 32, . . . , 3n to a common memory on the basis of the transfer clock TCLK.

### BACKGROUND OF THE INVENTION

1. Field of the Invention

The present invention relates to transfer control when a plurality of master devices access a common memory, and particularly to a method of implement efficient power management and proper band width scheduling.

2. Description of the Related Art

According to a conventional common memory transfer control circuit, for example, in a case where transfer information is received from a plurality of master devices, when a transfer request received from a master device that strongly needs real-time processing competes with requests from other master devices, the “waiting-possible longest time” of the master device needing the real-time processing is compared with a “a scheduled time for which a common memory is occupied” calculated from registration information of the master devices other than the above master device concerned by using the value of a dedicated timer provided every master device, and bus arbitration in the common memory access is carried out (for example, see JP-A-2000-148668).

In the conventional common memory transfer control circuit, a transfer clock frequency corresponding to a broad band width at the peak time is fixedly used, and thus the high transfer clock frequency corresponding to the peak time is kept to be set even in a time zone in which the broad band width is not required. Therefore, power is wastefully consumed because the transfer clock frequency is excessively high with respect to the data transfer amount.

On the other hand, in a lock gating method of supplying clocks at a necessary timing, the power consumption can be reduced. However, in this case, the frequency during the operation is kept constant in the conventional method, and thus it cannot contribute to suppression of rush current.

### SUMMARY OF THE INVENTION

The present invention has an object to provide a common memory transfer control circuit for implementing efficient power management and proper band width scheduling.

A common memory transfer control circuit of the present invention is characterized in that a preferential level signal indicating a transfer urgency level is received from a plurality of master devices making transfer requests to a common memory, bus arbitration among the respective master devices is carried out on the basis of the information concerned, and also when the number of congested requests from the master devices is small and also the urgency level of each request is low, the transfer clock frequencies containing the common memory transfer control circuit itself and the common memory are lowered and sufficiently suppressed to the frequencies for selection of drive capability to the common memory, thereby performing dynamic control.

According to the present invention, the access of the plural master devices to the common memory is arbitrated, and the optimal transfer clock frequency and the optimal drive capability to the common memory are selected, whereby the power consumption can be saved without failing to secure the necessary band width under the maximum load, and unnecessary rush current can be suppressed.

According to a first aspect of a common transfer control circuit of the present invention, a common memory transfer control circuit for arbitrating an access right to a common memory on the basis of transfer request signals and transfer request level signals indicating urgency levels of transfer requests that are transmitted from plural master devices, comprises: a transfer request congestion number detecting circuit for detecting a transfer request congestion number indicating the multiplicity of transfer requests from the transfer request signals; a transfer request level signal maximum value detecting circuit for detecting a transfer request level signal maximum value from the transfer request level signals; a transfer clock controller for controlling the frequency of a transfer clock on the basis of the transfer request congestion number and the transfer request level signal maximum value; and an access right arbitrating circuit for arbitrating the access right of the plural master devices to the common memory on the basis of the transfer clock.

According to the above construction, the access of the plural master devices to the common memory is arbitrated, and the optimal transfer clock frequency and the drive capability to the common memory are selected, whereby the efficient power management and the proper band width scheduling can be implemented.

In the common memory transfer control circuit according to the present the transfer clock controller increases the transfer clock frequency when the sum of the transfer request congestion number and the transfer request level signal maximum value is equal to a predetermined value or more, and reduces the transfer clock frequency when the sum is less than the predetermined value.

According to the above construction, the transfer clock is controlled interlockingly with the sum of the transfer request congestion number and the request level maximum value at all times, whereby the frequency of the transfer clock can be reduced without losing a necessary transfer band width and the power consumption can be saved.

Furthermore, in the common memory transfer control circuit according to the present invention, the transfer clock controller stops the transfer clock when there exists no transfer request from the plural master devices.

The common memory transfer control circuit according to the present invention further comprises an I/O port for varying drive capability to the common memory in connection with the frequency of the transfer clock.

According to the above construction, the drive capability of the I/O port is adjusted in connection with the transfer clock frequency to the common memory, so that the power consumption of the common memory transfer control circuit and the common memory can be further saved.

Furthermore, according to the present invention, a common memory transfer control circuit for arbitrating an access right to a common memory on the basis of transfer request signals and transfer request level signals indicating urgency levels of transfer requests that are transmitted from plural master devices, comprises: a transfer request congestion number detecting circuit for detecting a transfer request congestion number indicating the multiplicity of transfer requests from the transfer request signals; a transfer request level signal maximum value detecting circuit for detecting a transfer request level signal maximum value from the transfer request level signals; a transfer clock controller for controlling the frequency of a first transfer clock supplied to the plural master devices and the frequency of a second transfer clock supplied to the common memory on the basis of the transfer request congestion number and the transfer request level signal maximum value; and an access right arbitrating circuit for arbitrating the access right of the plural master devices to the common memory on the basis of the first and second transfer clocks.

According to the above construction, the power consumption can be saved without increasing the inner logic frequency, and the total bandwidth can be expanded by increasing only the clock frequency supplied to the common memory.

In the common memory transfer control circuit according to the present invention, the frequencies of the first and second transfer clocks have linear multiplying relation.

According to the present invention, the access of the plural master devices to the common memory is arbitrated, and the optimal transfer clock frequency and the optimal drive capability to the common memory which are neither excessive nor deficient at that time point are selected, whereby the power consumption can be saved without failing to secure the necessary band width under the maximum load. Furthermore, by reducing the frequency, unnecessary rush current can be suppressed.

### BRIEF DESCRIPTION OF THE DRAWINGS

FIG. 1 is a diagram showing the construction of a common memory transfer control system according to a first embodiment of the present invention.

FIG. 2 is a flowchart showing the operation of a common memory transfer control circuit according to the first embodiment of the present invention.

FIG. 3 is a time chart showing a control method of the common memory transfer control circuit according to the first embodiment of the present invention.

FIG. 4 is a diagram showing the construction of a common memory transfer control circuit according to a second embodiment of the present invention.

FIG. 5 is a diagram showing the construction of a common memory transfer control circuit according to a third embodiment of the present invention.

### DESCRIPTION OF THE PREFERRED EMBODIMENTS

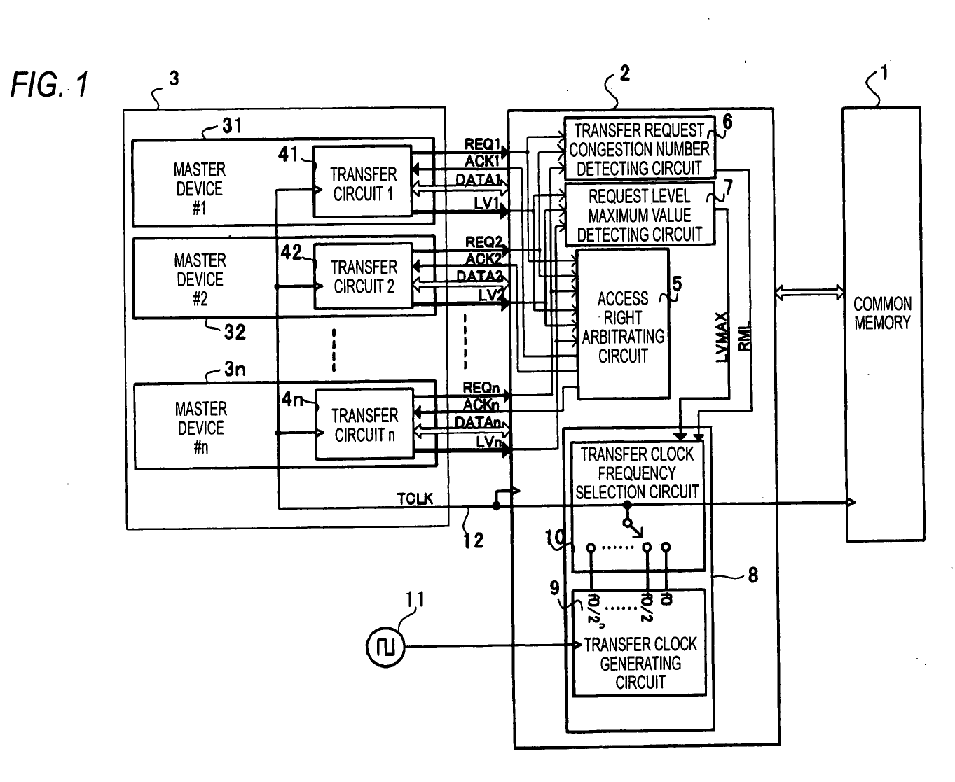

FIG. 1 is a diagram showing the construction of a common memory transfer control system according to a first embodiment of the present invention. In the common memory transfer control system of this embodiment, an access of plural master devices 31, 32, . . . , 3n each having a function of controlling data transfer to a common memory 1 is arbitrated by a common memory transfer control circuit 2.

The common memory transfer control circuit 2 arbitrates access rights on the basis of transfer request signals REQ1 to REQn and transfer request level signals LV1 to LVn indicating urgency levels of the transfer requests which are supplied from transfer circuits 41, 42, . . . , 4n of plural master devices 31, 32, . . . , 3n.

The common memory transfer control circuit 2 comprises a transfer request congestion number detecting circuit 6 for detecting a transfer request congestion number RML indicating the multiplicity of transfer requests, a transfer request level signal maximum value detecting circuit 7 for detecting a transfer request level signal maximum value LVMAX corresponding to the maximum value from the transfer request level signals LV1 to LVn, a transfer clock controller 8 for controlling the frequency of a transfer clock TCLK on the basis of the transfer request congestion number RML and the transfer request level signal maximum value LVMAX, and an access right arbitrating circuit 5 for arbitrating access rights of the plural master devices 31, 32, . . . , 3n to the common memory 1.

Furthermore, the transfer clock controller 8 divides the frequency of a reference clock supplied from a clock generator 11 for generating the reference clock having a frequency f0 to generate frequency-divided clocks having frequencies of f0/2, . . . f0/2ⁿ, and a transfer clock frequency selecting circuit 10 for selecting a desired transfer clock TCLK from the frequency-divided clocks.

The transfer request signals REQ1 to REQn and the transfer request level signals LV1 to LVn are output from the transfer circuits 41, 42, . . . , 4n of the master device group 3 to the common memory transfer control circuit 2, and conversely transfer acknowledge signals ACK1 to ACKn from the common memory transfer control circuit 2 to the transfer circuits 41, 42, . . . , 4n.

Data input/output buses DATA1, DATA2, . . . , DATAn are connected between the common memory transfer control circuit 2 and the transfer circuits 41, 42, . . . , 4n. The transfer request signals REQ1 to REQn are input to the transfer request congestion number detecting circuit 6 as well as the access right arbitrating circuit 5 in the common memory transfer control circuit 2. Furthermore, the transfer request level signals LV1 to LVn are input to the request level maximum value detecting circuit 7 as well as the access right arbitrating circuit 5.

When a transfer request to the common memory 1 occurs, each of the master devices 31, 32, . . . , 3n makes the corresponding transfer request signal REQ1 to REQn active, and at the same time it transmits the urgency level of the transfer request of the master device concerned as a status signal to the common memory transfer control circuit 2.

The common memory transfer control circuit 2 issues an access right allowance on the basis of the information of the transfer request signals REQ1 to REQn and the transfer request level signals LV1 to LVn in the access right arbitrating circuit 5. If the transfer requests are congested, the common memory transfer control circuit 2 determines the access right in the decreasing order of the request level, and uses the transfer acknowledge signals ACK1 to ACKn to notify it to only the master device concerned that the master device concerned can an access right.

The transfer request congestion number detecting circuit 6 monitors the transfer request signals REQ1 to REQn from the respective master devices 31, 32, . . . , 3n to detect the transfer request congestion number RML, and transmits the transfer request congestion number RML thus detected to the transfer clock frequency selecting circuit 10. The request level maximum value detecting circuit 7 monitors the transfer request level signals LV1 to LVN from the respective master devices 31, 32, . . . 3n, and transmits the maximum request level value LVMAX to the transfer clock frequency selecting circuit 10. As the transfer request level signal maximum value LVMAX is larger, the urgency level of the transfer request is higher.

On the basis of the transfer request congestion number RML and the request level maximum value LVMAX, the transfer clock frequency selecting circuit 10 selects, from the plural clock frequencies CLK0 to CLKn (F0, F0/2, . . . , f0/2ⁿ) generated in the transfer clock generating circuit 9, the minimum clock frequency at which a necessary band width can be secure, and supplies it as a transfer (synchronous) clock TCLK of the transfer circuits 41, 42, . . . , 4n, the common memory transfer control circuit 2 and the common memory 1.

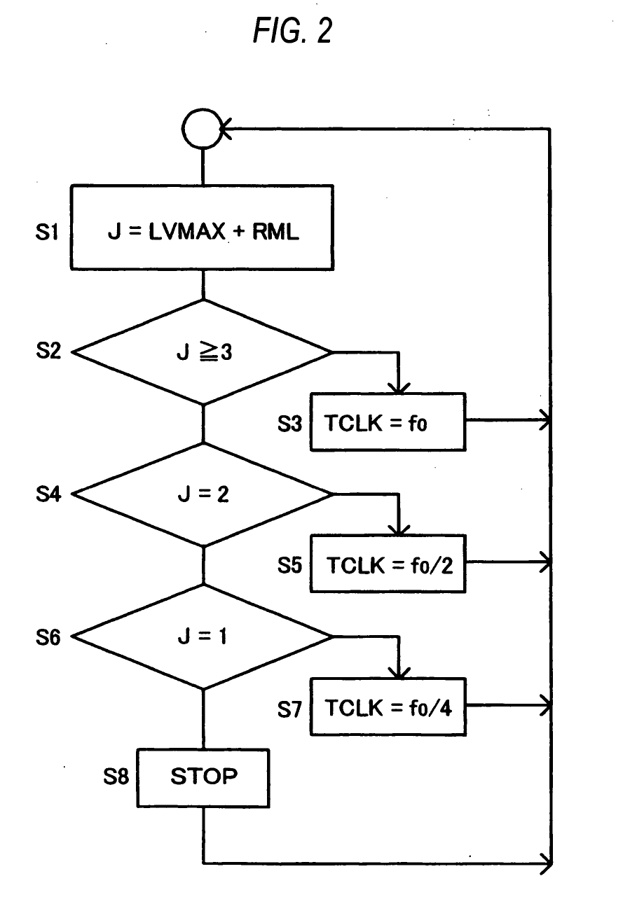

FIG. 2 is a flowchart showing an example of a specific condition under which the common memory transfer control circuit 2 controls the transfer clock frequency selecting circuit 10 in the common memory transfer control system according to the first embodiment of the present invention. The transfer request level signal maximum value LVMAX is an output of the request level maximum value detecting circuit 7, and represents the maximum request level value. Furthermore, the transfer request congestion number RML is an output from the transfer request congestion number detecting circuit 6, and represents the congestion degree of the transfer requests.

The sum of the transfer request congestion number RML and the transfer request level signal maximum value LVMAX is represented by J value (step S1), and the frequency of the transfer clock TCLK is selected on the basis of the J value. When J is equal to 3 or more at some time point (step S2), the frequency of the transfer clock TCLK is set to a reference frequency f0 (step S3).

Furthermore, when J is equal to 2 at some time point (step S4), the frequency of the transfer clock TCLK is set to a half of the reference frequency, that is, f0/2 (step S5). When J is equal to 1 (step S6), the frequency of the transfer clock TCLK is set to a quarter of the reference frequency (step S7). Furthermore, in the other cases, that is, when J is equal to 0, no transfer request occurs at this time point, and the transfer clock TCLK is set to STOP, that is, a stop state (step S8).

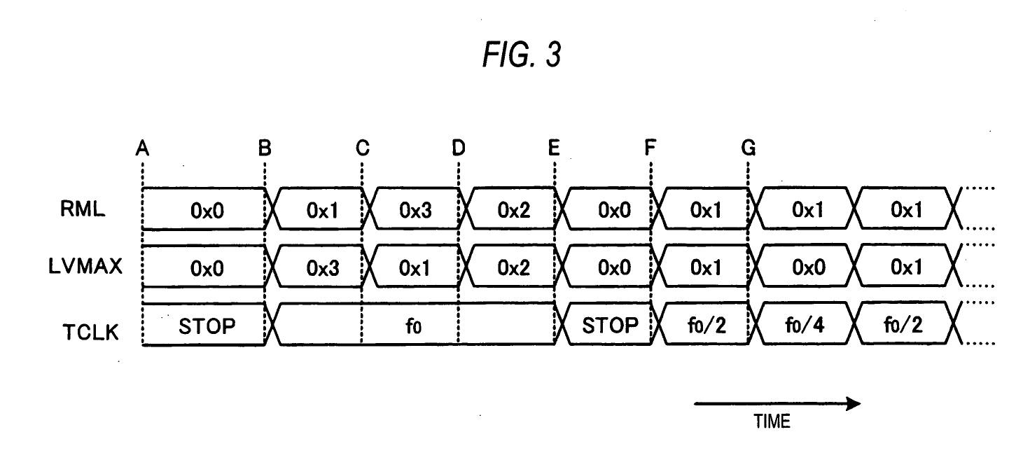

FIG. 3 is a flowchart showing a specific condition under which the common memory transfer control circuit 2 of the first embodiment of the present invention controls the transfer clock frequency selecting circuit 10. The ordinate axis represents the transfer request congestion number RML, the transfer request level signal maximum value LVMAX and the transfer clock TCLK, and the abscissa axis represents the time.

As shown in FIG. 3, from a time point A till a time point B, J=RML+LVMAX=0 is satisfied and thus the transfer clock TCLK is stopped. When passing over the time point B, J=RML+LVMAX=4 is satisfied, and further J≦3 is satisfied, so that the frequency of the transfer clock TCLK is equal to the maximum value f0. At time points C and D, the condition of J≦3 is not changed, and thus the frequency of the transfer clock TCLK keeps f0.

At a time point E, J=RML+LVMAX=0 is satisfied again, and the transfer clock TCLK is stopped. At a time point F, J=RML+LVMAX=2 is satisfied, and the frequency of the transfer clock TCLK is equal to a half of the maximum frequency, that is, f0/2. Furthermore, at a time point G, J=RML+LMAX=1 is satisfied, the frequency is controlled to be reduced till a quarter of the maximum frequency, that is, f0/4.

As described above, the transfer clock TCLK is controlled interlockingly with the sum of the transfer request congestion number RML and the request level maximum value LVMAX at all times, so that the power consumption can be saved by reducing the frequency of the transfer clock TCLK without diminishing the necessary transfer band.

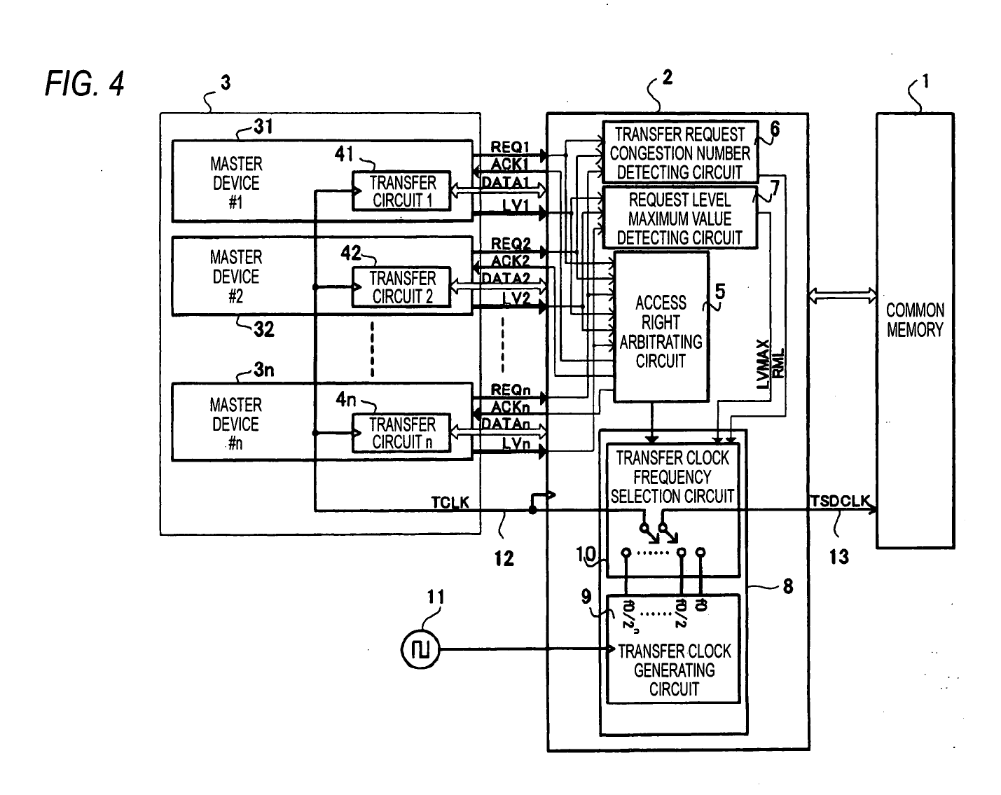

FIG. 4 is a diagram showing the construction of a common memory transfer control circuit 2 according to a second embodiment of the present invention. The common memory transfer control circuit 2 of this embodiment is different from the first embodiment in that the transfer clock frequency selecting circuit 10 of the transfer clock controller 8 individually selects transfer clocks TCLK and TSDCLK for two systems from the plural clock frequencies CLK0 to CLKn (f0, f0/2, . . . , f0/2ⁿ) generated in the transfer clock generating circuit 9.

The master devices 3l, 32, . . . , 3n access the common memory 1 through the arbitration of the common memory transfer control circuit 2. The transfer request signals REQ1 to REQn and the transfer request level signals LV1 to LVn are output from the transfer circuits 41, 42, . . . , 4n of the master device group 3 to the common memory transfer control circuit 2, and conversely the transfer acknowledge signals ACK1 to ACKn are input from the common memory transfer control circuit 2 to the transfer circuits 41, 42, . . . , 4n. Furthermore, a data input bus is connected between the common memory transfer control circuit 2 and each of the transfer circuits 41, 42, . . . , 4n.

The transfer request signals REQ1 to REQn are input to the transfer request congestion number detecting circuit 6 as well as the access right arbitrating circuit 5 in the common memory transfer control circuit 2. The transfer request level signals LV1 to LVn are input to the request level maximum value detecting circuit 7 as well as the access right arbitrating circuit 5.

The transfer clock controller 8 comprises the transfer clock generating circuit 9 and the transfer clock frequency selecting circuit 10. The transfer clock generating circuit 9 carries out frequency division multiply on a clock signal from the clock generator 11 to generate plural frequency clocks CLK0 to CLKN.

When a transfer request to the common memory 1 occurs, each of the master devices 31, 32, . . . , 3n makes active the transfer request signal REQ1 to REQn corresponding to the master device concerned, and at the same time it uses the transfer request level signal LV1 to LVn to transmit the urgency level of the transfer request of the master device concerned as a status signal to the common memory transfer control circuit 2.

In the common memory transfer control circuit 2, the access right allowance is issued in the access right arbitrating circuit 5 on the basis of the information of the transfer request signals REQ1 to REQn and the transfer request level signals LV1 to LVn. If transfer requests are congested, the access right is determined in the decreasing order of the request level, and by using the transfer acknowledge signals ACK1 to ACKn, it is notified to only the corresponding master device that the access right can be achieved.

The transfer request congestion detecting circuit 6 monitors the transfer request signal REQ1 to REQn from the respective master devices 31, 32, . . . , 3n to detect the congestion number RML of transfer requests, and transmits it to the transfer clock frequency selecting circuit 10. It is indicated that as the value of the transfer request level signal maximum value LVMAX is larger, the urgency level of the transfer request is higher.

The transfer clock frequency selecting circuit 10 selects the minimum clock frequency at which a necessary band width can be secured, from the plural clock frequencies CLK0 to CLKn occurring in the transfer clock generating circuit 9 on the basis of the transfer request congestion number RML and the request level maximum value LVMAX, and it supplies the transfer (synchronous) clock TCLK 12 to the transfer circuits 41, 42, . . . , 4n and the common memory transfer control circuit 2 and also supplies the transfer (synchronous) clock TSDCLK 13 to the common memory 1.

At this time, the synchronous clock TCLK 12 for the transfer circuits 41, 42, . . . , 4n and the common memory transfer control circuit 2 is controlled as in the case of the first embodiment, however, the synchronous clock TSDCLK 13 for the common memory 1 is controlled independently of the synchronous clock TCLK 12 at all times. In this case, the synchronous clock TSDCLK 13 is controlled so that the synchronous clock TCLK 12 and the clock frequency keep the proportional relationship with each other at all times.

According to this embodiment, the power consumption can be saved without increasing the inner logic frequency TCLK 12, and the total band width can be expanded by increasing only the clock frequency TSDCLK 13 supplied to the common memory 1.

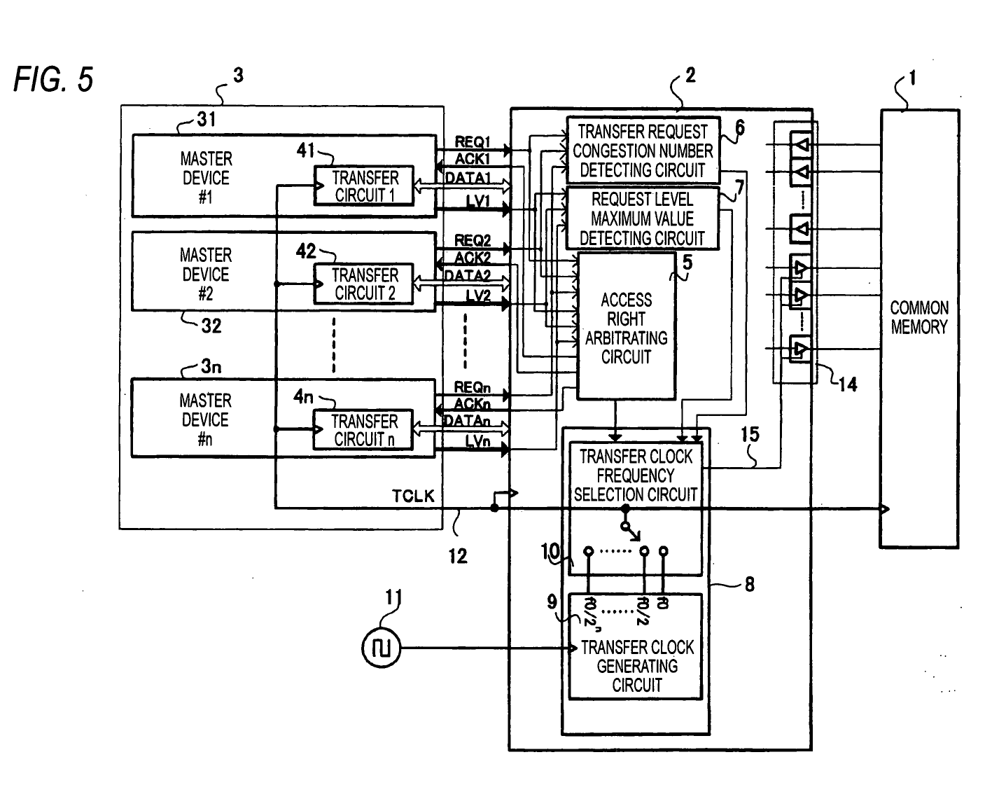

FIG. 5 is a diagram showing the construction of the common memory transfer control circuit 2 according to a third embodiment of the present invention. The common memory transfer control circuit 2 of this embodiment is different from that of the first embodiment in that a drive capability switching control signal 15 corresponding to the transfer clock selected in the transfer clock frequency selecting circuit 10 is supplied to an I/O port for access to the common memory 1.

The master devices 31, 32, . . . , 3n access the common memory 1 through the arbitration of the common memory transfer control circuit 2. The transfer request signals REQ1 to REQn and the transfer request level signals LV1 to LVn are output from the transfer circuits 41, 42, . . . , 4n of the master device group 3 to the common memory transfer control circuit 2, respectively, and the transfer acknowledge signals ACK1 to ACKn are input from the common memory transfer control circuit 2 to the transfer circuits 41, 42, . . . , 4n. The data input/output bus is connected between the common memory transfer control circuit 2 and each of the transfer circuits 41, 42, . . . , 4n.

The transfer request signals REQ1 to REQn are input to the transfer request congestion number detecting circuit 6 as well as the access right arbitrating circuit 5 in the common memory transfer control circuit 2. The transfer request level signals LV1 to LVn are input to the request level maximum value detecting circuit 7 as well as the access right arbitrating circuit 5.

The transfer clock controller 8 comprises the transfer clock generating circuit 9 and the transfer clock frequency selecting circuit 10. The transfer clock generating circuit 9 subjects a clock signal from the clock generator 11 to frequency division multiplication to generate plural frequency clocks CLK0 to CLKn.

When a transfer request to the common memory 1 occurs, each of the master devices 31, 32, . . . , 3n makes active the transfer request signal REQ1 to REQn corresponding to the master device concerned, and at the same time it transmits the urgency level of the transfer request of the master device concerned as a status signal to the common memory transfer control circuit 2 by using the transfer request level signal LV1 to LVn.

The common memory transfer control circuit 2 issues access right allowance in the access right arbitrating circuit 5 on the basis of the information of the transfer request signals REQ1 to REQn and the transfer request level signals LV1 to LVn. If transfer requests are congested, the common memory transfer control circuit 2 determines the access right in the decreasing order of the request level, and by using the transfer acknowledge signal ACK1 to ACKn, the common memory transfer control circuit 2 notifies it to only one master device concerned that the master device concerned can achieve the access right.

The transfer request congestion number detecting circuit 6 monitors the transfer request signals REQ1 to REQn from the respective mater devices 31, 32, . . . , 3n to detect the transfer request congestion number RML, and transmits it to the transfer clock frequency selecting circuit 10. The request level maximum value detecting circuit 7 monitors the transfer request level signals LV1 to LVn from the master devices 31, 32, . . . , 3n, and likewise transmits the maximum request level value LVMAX to the transfer clock frequency selecting circuit 10. As the value of the transfer request level signal maximum value LVMAX is higher, the urgency level of the transfer request is higher.

The transfer clock frequency selecting circuit 10 selects the minimum clock frequency at which a necessary band width can be secured, from the plural clock frequencies CLK0 to CLKn occurring in the transfer clock generating circuit 9 on the basis of the transfer request congestion number RML and the request level maximum value LVMAX, and supplies the synchronous clock TCLK 12 to the transfer circuits 41, 42, . . . , 4n, the common memory transfer control circuit 2 and the common memory 1.

The I/O port 14 is a portion for accessing the common memory1, and it is supplied with a control signal 15 for switching the output drive capability thereof from the transfer clock frequency selecting circuit 10. The control signal 15 interlocks with the frequency of the transfer clock TCLK 12, for example, when the transfer clock frequency is switched to f0/2 or less, the control signal 15 controls the drive capability of the I/O port 14 so that the drive capability is suppressed.

According to this embodiment, the drive capability of the I/O port 14 of the common memory transfer control circuit 2 can be adjusted in connection with the transfer clock frequency to the common memory 1, and thus the power consumption of the common memory transfer control circuit 2 and the common memory 1 can be further saved.

The common memory control circuit of the present invention arbitrates the access of the plural master devices to the common memory and at the same time it selects the optimal transfer clock frequency and drive capability to the common memory which are neither excessive nor deficient at that time point, whereby the power consumption can be saved without failing to secure the necessary band width under the maximum load. Furthermore, there is an effect that unnecessary rush current can be suppressed by reducing the frequency, and the present invention is effectively used as a method of implementing transfer control, particularly efficient power management and proper band width scheduling when plural master devices access the common memory.

What is claimed is:

1. A common memory transfer control circuit for arbitrating an access right to a common memory on the basis of transfer request signals and transfer request level signals indicating urgency levels of transfer requests that are transmitted from plural master devices, comprising:
a transfer request congestion number detecting circuit for detecting a transfer request congestion number indicating the multiplicity of transfer requests from the transfer request signals;
a transfer request level signal maximum value detecting circuit for detecting a transfer request level signal maximum value from the transfer request level signals;
a transfer clock controller for controlling the frequency of a transfer clock on the basis of the transfer request congestion number and the transfer request level signal maximum value; and
an access right arbitrating circuit for arbitrating the access right of the plural master devices to the common memory on the basis of the transfer clock.

2. The common memory transfer control circuit according to claim 1, wherein the transfer clock controller increases the transfer clock frequency when the sum of the transfer request congestion number and the transfer request level signal maximum value is equal to a predetermined value or more, and reduces the transfer clock frequency when the sum is less than the predetermined value.

3. The common memory transfer control circuit according to claim 1, wherein the transfer clock controller stops the transfer clock when there exists no transfer request from the plural master devices.

4. The common memory transfer control circuit according to claim 1, further comprising an I/O port for varying drive capability to the common memory in connection with the frequency of the transfer clock.

5. A common memory transfer control circuit for arbitrating an access right to a common memory on the basis of transfer request signals and transfer request level signals indicating urgency levels of transfer requests that are transmitted from plural master devices, comprising:
a transfer request congestion number detecting circuit for detecting a transfer request congestion number indicating the multiplicity of transfer requests from the transfer request signals;
a transfer request level signal maximum value detecting circuit for detecting a transfer request level signal maximum value from the transfer request level signals;
a transfer clock controller for controlling the frequency of a first transfer clock supplied to the plural master devices and the frequency of a second transfer clock supplied to the common memory on the basis of the transfer request congestion number and the transfer request level signal maximum value; and
an access right arbitrating circuit for arbitrating the access right of the plural master devices to the common memory on the basis of the first and second transfer clocks.

6. The common memory transfer control circuit according to claim 5, wherein the frequencies of the first and second transfer clocks have linear multiplying relation.
